(19) United States
(12) Patent Application Publication
(10) Pub. No.: US 2010/0046124 A1
(43) Pub. Date: Feb. 25, 2010

(54) Boost DC-DC converter control circuit and boost DC-DC converter having protection circuit interrupting overcurrent

(75) Inventor: Yasuhiro Hibi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/461,512

(22) Filed: Aug. 13, 2009

(30) Foreign Application Priority Data
Aug. 19, 2008 (JP) 2008-210647

(51) Int. Cl. H02H 7/10

(52) U.S. Cl. 361/18

(57) ABSTRACT

A boost DC-DC converter control circuit includes a transistor which is disposed between an input terminal and an output terminal of a boost DC-DC converter, and which is configured to interrupt an overcurrent between the two terminals. The control circuit includes an amplifier configured to amplify a difference between a voltage of the transistor on a side of the input terminal and a voltage of the transistor on a side of the output terminal, and a comparator configured to compare an output voltage from the amplifier with a predetermined reference voltage. On- and off-states of the transistor are controlled in response to an output voltage from the comparator.

### INCORPORATION BY REFERENCE

This application is based upon and claims the benefit of priority from Japanese Patent Application No. 2008-210647 which was filed on Aug. 19, 2008, the disclosure of which is incorporated herein in its entirety by reference.

### BACKGROUND OF THE INVENTION

1. Field of the Invention

The present invention relates to a boost DC-DC converter control circuit and a boost DC-DC converter including the same.

2. Description of Related Art

Boost DC-DC converters have been widely used in various electrical and electronic equipment. Such boost DC-DC converters often include a protection circuit for interrupting an overcurrent caused by short-circuit or the like.

FIG. 4 is an overcurrent protection circuit described in FIG. 1 of Patent Document 1. In the figure, a direct current power supply E is connected between input terminals T1 and T2, and a load LD is connected between output terminals T3 and T4. A converting unit CV of a DC-DC converter of, for example, a boost type, includes a coil L1, a diode D1, an output smoothing capacitor C1, a switching transistor Q1, output voltage detection resistors R1 and R2, and a pulse width modulation circuit PWM.

A protection circuit unit 1 and an overcurrent detection circuit unit 2 are provided between the input terminals T1 and T2 and the converting unit CV. A control circuit unit 3 controls the protection circuit unit 1 upon receipt of an output from the overcurrent detection circuit unit 2. The protection circuit unit 1 is configured of: a transistor Q2 for overcurrent protection, the transistor Q2 being inserted in a plus-side line; resistors R3 and R4 which apply a bias voltage to the transistor Q2; and a capacitor C2 for starting the transistor Q2.

The overcurrent detection circuit unit 2 includes an input current detection resistor R5 which is inserted in the plus-side line. Resistors R6 and R7 which are connected in series are connected between one end of the input current detection resistor R5 and a ground-side line. Resistors R8 and R9 which are connected in series are connected between the other end of the input current detection resistor R5 and the ground-side line.

The control circuit unit 3 includes an error amplifier A and a controlling unit CL. A voltage E1 at a connection portion of the resistors R6 and R7 which are connected in series and a voltage E2 at a connection portion of the resistors R8 and R9 which are connected in series are inputted to the error amplifier A. The error amplifier A gives the controlling unit CL a signal with a size corresponding to a difference E1˜E2 between the voltage E1 and the voltage E2 to be inputted.

A diode D2 which is connected between the plus-side line and the ground-side line is provided between the overcurrent detection circuit unit 2 and the converting unit CV. The diode D2 is for discharging energy of the coil L1 when the switching transistor Q2 is turned off. A capacitor C3 is a smoothing capacitor.

In the circuit configuration described in Patent Document 1, a current flowing through the input current detection resistor R5 is detected to determine whether the current is overcurrent. When the current is detected as overcurrent, the transistor Q2 for overcurrent protection is turned off to interrupt the current.

[Patent Document 1] Japanese Unexamined Patent Application Publication Hei 5-199740

### SUMMARY

In the circuit configuration described in Patent Document 1, even when the transistor Q2 for overcurrent protection is turned on, that is, even when the circuit normally operates, power is consumed in the input current detection resistor R5. For this reason, the boost DC-DC converter circuit as a whole has a problem of a deteriorated efficiency in the end.

A boost DC-DC converter control circuit includes:

a transistor which is disposed between an input terminal and an output terminal of a boost DC-DC converter, and which is configured to interrupt an overcurrent between the input and output terminals;

an amplifier configured to amplify a difference between a voltage of the transistor on a side of the input terminal and a voltage of the transistor on a side of the output terminal; and

a comparator configured to compare an output voltage from the amplifier with a predetermined reference voltage, in which on- and off-states of the transistor are controlled in response to an output signal from the comparator.

Based on the configuration, the boost DC-DC converter can protect an overcurrent with low power consumption and high efficiency.

### BRIEF DESCRIPTION OF THE DRAWINGS

The above and other exemplary aspects, advantages and features of the present invention will be more apparent from the following description of certain exemplary embodiments taken in conjunction with the accompanying drawings, in which:

FIG. 1 is a circuit diagram of a boost DC-DC converter according to a first exemplary embodiment of the present invention.

FIG. 2 is a timing chart of the boost DC-DC converter according to the first exemplary embodiment of the present invention.

FIG. 3 is a circuit diagram of a boost DC-DC converter according to a second exemplary embodiment of the present invention.

FIG. 4 is FIG. 1 of Patent Document 1.

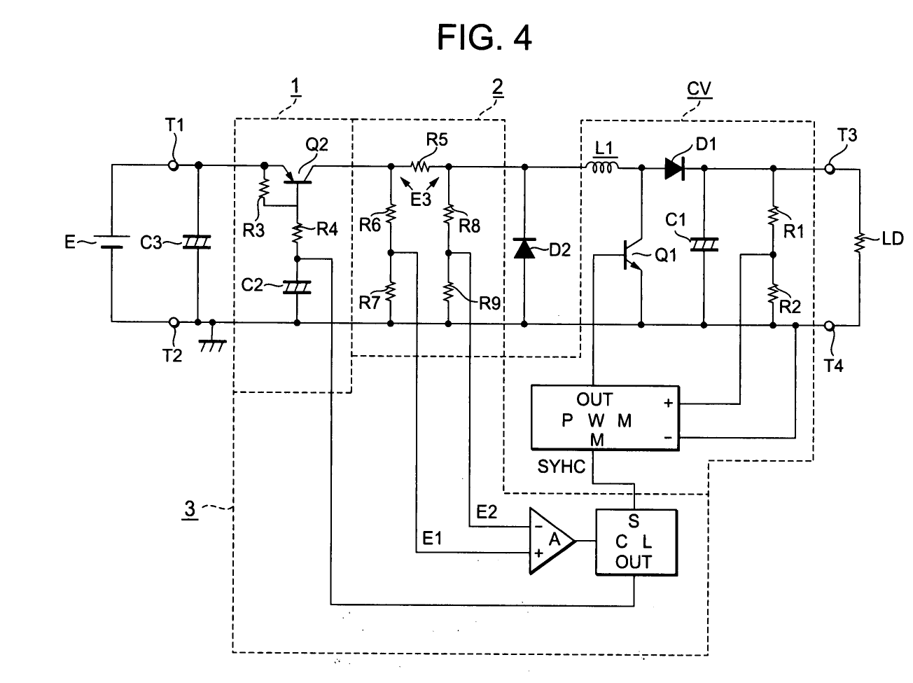

### DETAILED DESCRIPTION OF THE EXEMPLARY EMBODIMENTS

### First Exemplary Embodiment

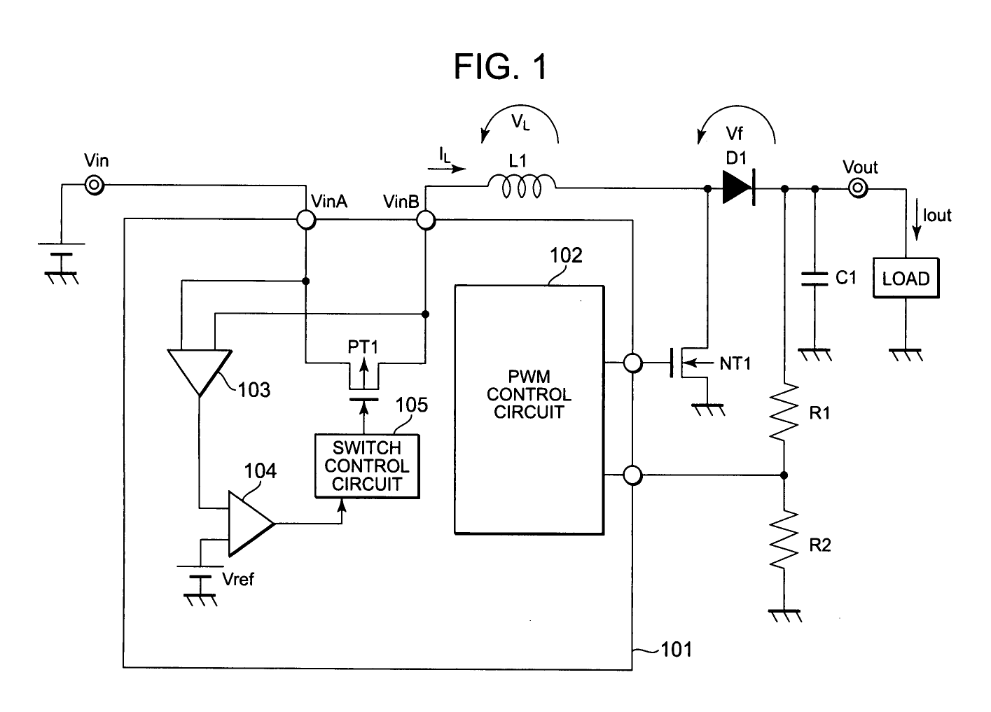

FIG. 1 is a circuit diagram of a boost DC-DC converter control circuit according to an exemplary embodiment and a boost DC-DC converter using the boost DC-DC converter control circuit. As shown in FIG. 1, the boost DC-DC converter includes a control IC 101, a PWM control circuit 102, an overcurrent protection transistor PT1, an amplifier 103, a comparator 104, a switch control circuit 105, a boost coil (inductor) L1, a switching transistor NT1, a diode D1, resistors R1 and R2, and a capacitor C1.

The PWM control circuit 102 is mounted on the control IC 101. The PWM control circuit 102 applies a gate voltage to the switching transistor NT1 and controls the switching transistor NT1. When the switching transistor NT1 is turned on, energy is stored in the coil L1. On the other hand, when the switching transistor NT1 is turned off, the stored energy is outputted via the diode D1 as an output voltage Vout of the boost DC-DC converter. As a result, a desired current lout is supplied to a load. Note that the capacitor C1 is a smoothing capacitor.

The switching transistor NT1 is an NMOS transistor. A source of the switching transistor NT1 is connected to a ground, and a drain thereof is connected to a node between the coil L1 and the diode D1.

Here, the output voltage Vout of the boost DC-DC converter is divided by the resistors R1 and R2. Then, an output pulse width of a pulse width modulation circuit PWM is controlled according to a detection voltage based on a ratio of the divided voltages. The pulse whose pulse width is controlled in such a manner is supplied to the gate of the switching transistor NT1. With such feedback control, the output voltage Vout of the boost DC-DC converter is kept constant.

The overcurrent protection transistor PT1 is also mounted on the control IC 101. The overcurrent protection transistor PT1 is a PMOS transistor, and a source thereof is connected to an input terminal of the boost DC-DC converter, and a drain thereof is connected to the coil L1. The overcurrent protection transistor PT1 may be a bipolar transistor. However, a MOS transistor consumes less power, which is therefore preferable.

The amplifier 103 is an amplifier including two input terminals and one output terminal. A source voltage VinA of the overcurrent protection transistor PT1 and a drain voltage VinB of the overcurrent protection transistor PT1 are respectively inputted to one of the input terminals and the other terminal. This amplifier 103 amplifies a difference between the source voltage VinA and the drain voltage VinB, and outputs the amplified difference from the output terminal.

The comparator 104 is a comparator including two input terminals and one output terminal. An output signal from the amplifier 103 and a reference voltage Vref are respectively inputted to one of the input terminals and the other input terminal. This comparator 104 compares the output signal from the amplifier 103 with the reference voltage Vref to output a signal from the output terminal. Here, when the output signal from the amplifier 103 is equal to or lower than the reference voltage Vref, a signal to turn on the overcurrent protection transistor PT1 is generated. On the other hand, when the output signal from the amplifier 103 is equal to or larger than the reference voltage Vref, a signal to turn off the overcurrent protection transistor PT1 is generated. Such a signal is inputted to a gate of the overcurrent protection transistor PT1 via the switch control circuit 105 formed of, for example, a buffer and the like.

Although the detail is described later, when a current IL passing through the coil L1 is increased due to short-circuit or the like on the load side, there is an increase in a difference between the source voltage VinA and the drain voltage VinB of the overcurrent protection transistor PT1 which is turned on in a normal state. When this difference exceeds a predetermined value, the overcurrent protection transistor PT1 is turned off. In the boost DC-DC converter control circuit according to the present invention, the difference between potentials of the source voltage VinA and the drain voltage VinB of the overcurrent protection transistor PT1 is directly detected. Accordingly, a resistor for detecting an overcurrent is unnecessary. Thus, the power consumption can be decreased.

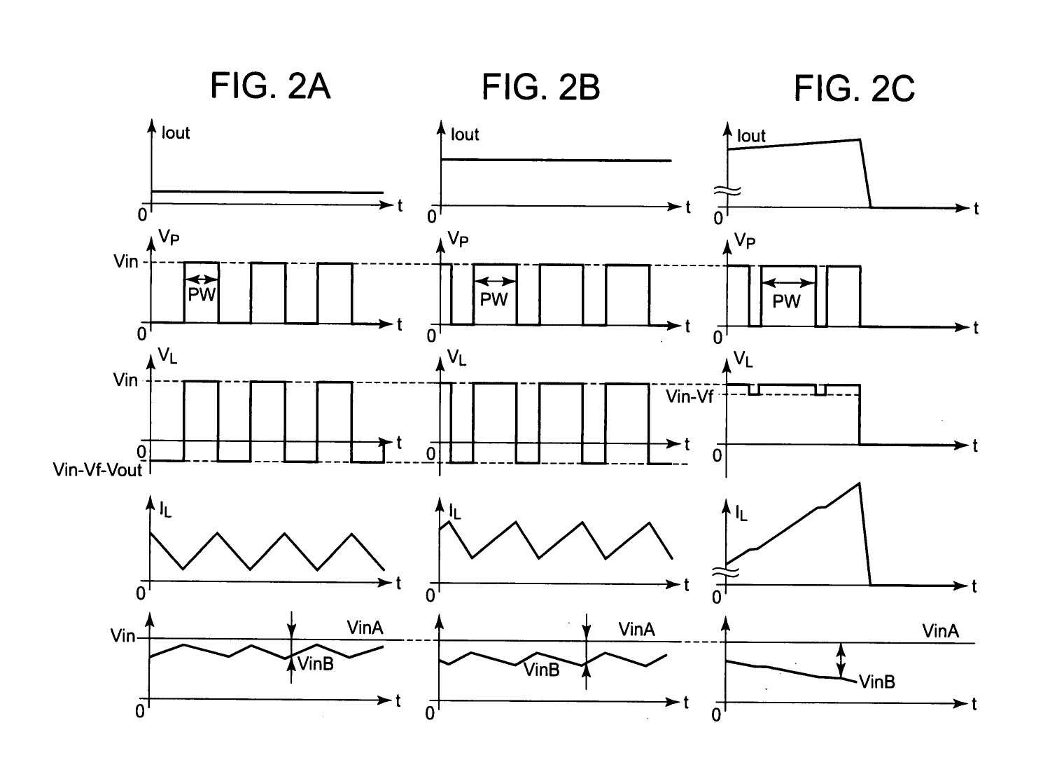

Next, the operation of the boost DC-DC converter of FIG. 1 is described by using timing charts of FIG. 2. FIG. 2A shows a case where the output current lout to be supplied to the load from the boost DC-DC converter is small, the output current lout being shown in the uppermost row of FIG. 2A. FIG. 2B shows a case where the output current lout is large. Both of FIGS. 2A and 2B are timing charts during a normal operation. On the other hand, FIG. 2C is a timing chart during an abnormal operation when short-circuit or the like occurs on the load side.

Graphs in the uppermost rows of FIGS. 2A to 2C show time variations of the output current lout to be supplied from the boost DC-DC converter to the load. Graphs in the second rows from the tops of FIGS. 2A to 2C show time variations of a voltage Vp to be supplied from the PWM control circuit 102 to the gate of the switching transistor NT1. Graphs in the third rows from the tops of FIGS. 2A to 2C show time variations of a voltage V_{L} between both ends of the coil L1. Graphs in the fourth rows from the tops of FIGS. 2A to 2C show time variations of the current I_{L} flowing through the coil L1. Graphs in the lowest rows of FIGS. 2A to 2C show time variations of the source voltage VinA and drain voltage VinB of the overcurrent protection transistor PT1.

Firstly, the normal operation is described by comparing FIG. 2A with FIG. 2B. When the output current lout is increased as shown in the graphs in the uppermost rows of FIGS. 2A and 2B, a pulse width PW of the gate potential Vp of the switching transistor NT1 is made larger by PWM control as shown in the graphs in the second rows from the tops of FIGS. 2A and 2B. The switching transistor NT1 is turned on when the gate potential Vp is Vin, and turned off when 0. Accordingly, the duration when the switching transistor NT1 is turned on becomes longer.

As shown in the graphs in the third rows from the tops of FIGS. 2A and 2B, when the switching transistor NT1 is turned on, Vin−V_{L}=0; thereby, the voltage V_{L} between both ends of the coil L1 becomes Vin. In this case, a current does not flow through the diode D1. On the other hand, when the switching transistor NT1 is turned off, a current flows through the diode D1, and thereby Vin−V_{L}−Vf=Vout. Accordingly, the voltage V_{L} between both ends of the coil L1 is Vin−Vf−Vout, which is a negative value. Here, Vf is a voltage between both ends of the diode D1.

As shown in the graphs in the fourth rows from the tops of FIGS. 2A and 2B, while the switching transistor NT1 is turned on, the current IL flowing through the coil L1 increases monotonously. On the other hand, when the switching transistor NT1 is turned off, the current I_{L} flowing through the coil L1 decreases monotonously. Here, the current I_{L} flowing through the coil L1 becomes generally large in FIG. 2B as compared with FIG. 2A.

As shown in the graphs in the lowest rows from the tops of FIGS. 2A and 2B, as the current I_{L} flowing through the coil L1 is larger, the difference between the source voltage VinA and the drain voltage VinB of the overcurrent protection transistor PT1 becomes larger. Here, the difference between the source voltage VinA and the drain voltage VinB becomes generally large in FIG. 2B as compared with FIG. 2A.

Next, the operation in an abnormal circumstance when short-circuit or the like occurs on the load side is described by using FIG. 2C. In this case, as shown in the graph in the uppermost row of FIG. 2C, the output current lout becomes extremely large. Accordingly, as shown in the graph in the second row from the top of FIG. 2C, the pulse width PW of the gate potential Vp of the switching transistor NT1 is maximized by the PWM control.

In addition, as shown in the graph in the third row from the top of FIG. 2C, when the switching transistor NT1 is turned on, the voltage V_{L} between both ends of the coil L1 becomes Vin as similar to FIGS. 2A and 2B. On the other hand, when the switching transistor NT1 is turned off, Vout is nearly equal to 0 due to short-circuit. Accordingly, the voltage V_{L} between both ends of the Vin coil is Vin−Vf, which is a positive value. For this reason, as shown in the graph in the fourth row from the top of FIG. 2C, the current I_{L} flowing through the coil L1 continuously increases. Thereby, as shown in the graph in the lowest row from the top of FIG. 2C, the difference between the source voltage VinA and the drain voltage VinB of the overcurrent protection transistor PT1 also continuously increases.

In the present invention, the difference between the source voltage VinA and the drain voltage VinB of the overcurrent protection transistor PT1 is amplified by the amplifier 103 as described above. Then, the comparator 104 compares the amplified difference with the reference voltage Vref. When the difference between the source voltage VinA and the drain voltage VinB of the overcurrent protection transistor PT1 exceeds this reference value, the overcurrent protection transistor PT1 is turned off. Accordingly, protection from overcurrent can be made.

As described above, in the boost DC-DC converter control circuit according to the present invention, the difference between potentials of the source voltage VinA and the drain voltage VinB of the overcurrent protection transistor PT1 is directly detected. Accordingly, a resistor for detecting an overcurrent is unnecessary. Thus, the power consumption can be decreased.

### Second Exemplary Embodiment

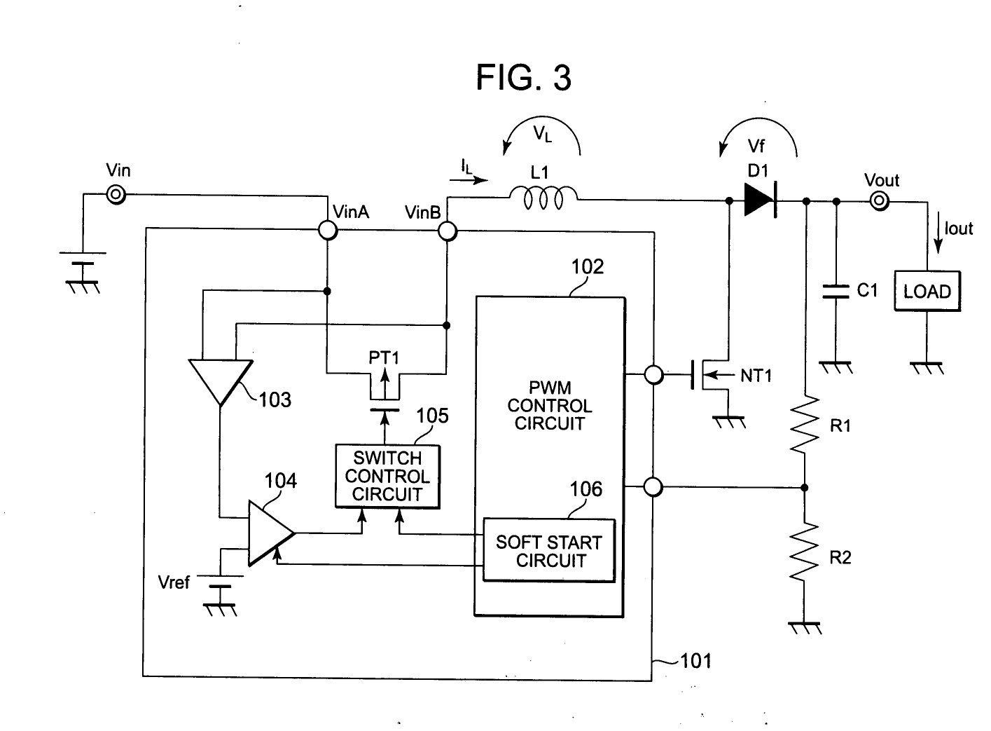

FIG. 3 is a circuit diagram of a boost DC-DC converter control circuit according to a second exemplary embodiment and a boost DC-DC converter using the boost DC-DC converter control circuit. The same reference numerals are given to denote circuit components that are the same as those of the first exemplary embodiment and the description thereof is omitted as appropriate. As shown in FIG. 3, the boost DC-DC converter control circuit according to the second exemplary embodiment further includes a soft start circuit 106 in the PWM control circuit. One of two signals to be outputted from the soft start circuit 106 is inputted to the comparator 104. The other signal is inputted to the overcurrent protection transistor PT1 via the switch control circuit 105.

Immediately after an input power supply is started, the output voltage Vout is not sufficiently increased yet. Accordingly, a rush current flows. For this reason, in the first exemplary embodiment, there is a fear that the overcurrent protection transistor PT1 might be turned off. In the second exemplary embodiment, the signal from the soft start circuit 106 causes the comparator 104 to stop for a predetermined period of time after the input power supply is started. During the same period, the signal from the soft start circuit 106 causes the overcurrent protection transistor PT1 to be kept turned on. In the meanwhile, after the input power supply is started and the predetermined period of time is over, the same operation as that of the first exemplary embodiment is performed.

Further, it is noted that Applicant's intent is to encompass equivalents of all claim elements, even if amended later during prosecution.

What is claimed is:

1. A boost DC-DC converter control circuit, comprising:
a transistor which is disposed between an input terminal and an output terminal of a boost DC-DC converter, and which is configured to interrupt an overcurrent between the input and output terminals;
an amplifier configured to amplify a difference between a voltage of the transistor on a side of the input terminal and a voltage of the transistor on a side of the output terminal; and
a comparator configured to compare an output voltage from the amplifier with a predetermined reference voltage, in order to provide an output signal to control on-and- off states of the transistor.

2. The boost DC-DC converter control circuit according to claim 1, wherein the transistor includes a MOS transistor.

3. The boost DC-DC converter control circuit according to claim 1, further comprising a control circuit configured to keep the transistor turned on for a predetermined period of time after an input power supply is started.

4. A boost DC-DC converter, comprising:
a transistor which is disposed between an input terminal and an output terminal of the boost DC-DC converter, and which is configured to interrupt an overcurrent between the input and output terminals;
an amplifier configured to amplify a difference between a voltage of the transistor on a side of the input terminal and a voltage of the transistor on a side of the output terminal;
a comparator configured to compare an output voltage from the amplifier with a predetermined reference voltage; and
an overcurrent protection circuit configured to control on-and-off states of the transistor in response to an output signal from the comparator.

5. The boost DC-DC converter according to claim 4, wherein the transistor includes a MOS transistor.

6. The boost DC-DC converter according to claim 4, further comprising a control circuit to keep the transistor turned on for a predetermined period of time after an input power supply is started.

7. The boost DC-DC converter according to claim 4, further comprising:
a boost coil;
a switching transistor connected in series to the boost coil; and
a diode having
one end connected to a node between the boost coil and the switching transistor, and
the other end connected to the output terminal, wherein
the transistor configured to interrupt an overcurrent is connected in series to the boost coil, between the input terminal and the boost coil.

8. A boost DC-DC converter, comprising:
a first terminal for receiving a voltage;
a second terminal;
a first transistor coupled between the first and second terminals;
an inductor coupled to the second terminal and a node;
a diode coupled between the node and the second terminal;
a resistor coupled between the second terminal and a power source terminal;
a second transistor coupled between the node and the power source terminal;
a pulse width modulation controller which controls the second transistor based on a voltage produced by the resistor; and
a switch control unit which controls the first transistor by monitoring a voltage difference between the first and second terminals so that the first transistor is turned off when the voltage difference becomes larger than a predetermined value.

9. The boost DC-DC converter, as claimed in claim 8, further comprising:
a soft start circuit which controls the switch control unit to keep the first transistor turned on for a predetermined period of time after the voltage is supplied to the first terminal.
